(19) United States
(12) Patent Application Publication
(10) Pub. No.: US 2026/0269139 A1
(43) Pub. Date: Sep. 10, 2026

(54) MULTI-UNIT MULTILAYER CERAMIC CAPACITOR

(71) Applicant: Murata Manufacturing Co., Ltd., Nagaokakyo-shi (JP)

(72) Inventor: Kazunori USUI, Nagaokakyo-shi (JP)

(21) Appl. No.: 19/533,892

(22) Filed: Feb. 9, 2026

(30) Foreign Application Priority Data
Mar. 5, 2025 (JP) 2025-034792

(51) Int. Cl. H01G 4/38; H01G 4/30

(52) U.S. Cl. CPC H01G 4/385; H01G 4/30

(57) ABSTRACT

A capacitor includes a multilayer body including capacitor units. Each of first inner electrode layers includes a first counter electrode portion, and a first extended portion protruding toward the first outer electrode. Each of second inner electrode layers includes a second counter electrode portion, and a second extended portion protruding toward the second outer electrode. The first extended portion includes a first exposed portion and the second extended portion includes a second exposed portion. The first exposed portion closest to a first side surface is convex toward the first side surface. The first exposed portion closest to a second side surface is convex toward the second side surface. The second exposed portion closest to the first side surface is convex toward the first side surface. The second exposed portion closest to the second side surface is convex toward the second side surface.

### CROSS REFERENCE TO RELATED APPLICATIONS

This application claims the benefit of priority to Japanese Patent Application No. 2025-034792 filed on Mar. 5, 2025. The entire contents of this application are hereby incorporated herein by reference.

### BACKGROUND OF THE INVENTION

### 1. Field of the Invention

The present invention relates to multi-unit multilayer ceramic capacitors.

### 2. Description of the Related Art

Along with improvement in performance of APUs (Accelerated Processing Units) to be used for smartphones, etc., impedance design has been more difficult to secure power supply stability during high-speed operation. Most common measures are to prepare a plurality of general two-terminal capacitors in which inner electrode layers are exposed on both end surfaces, appropriately select the two-terminal capacitors depending on different frequency characteristics, and dispose the two-terminal capacitors in parallel on power supply lines, thereby reducing impedance over a wide band.
Japanese Unexamined Patent Application Publication No. 2019-179928 is an example of related art.

### SUMMARY OF THE INVENTION

However, there is concern that this method has problems of an increase in costs and a decrease in yields due to an increase in number of mounted components.

Therefore, example embodiments of the present invention provide multi-unit multilayer ceramic capacitors in each of which reduction in costs and improvement in yields are achieved and production efficiency is improved.

A multilayer ceramic capacitor according to an example embodiment of the present invention is a multi-unit multilayer ceramic capacitor including a multilayer body including a first side surface and a second side surface that face each other in a lamination direction, a first principal surface and a second principal surface that face each other in a height direction orthogonal to the lamination direction, and a first end surface and a second end surface that face each other in a length direction orthogonal to both the lamination direction and the height direction; a first outer electrode extending in the lamination direction on the second principal surface, and a second outer electrode extending in the lamination direction on the second principal surface. The multilayer body includes, inside a single element assembly, a plurality of capacitor units each including a plurality of dielectric layers and a plurality of inner electrode layers. The plurality of capacitor units are positioned at predetermined intervals in the length direction and the lamination direction. The inner electrode layers include first inner electrode layers connected to the first outer electrode, and second inner electrode layers connected to the second outer electrode. Each of the first inner electrode layers includes a first counter electrode portion, and a first extended portion protruding toward the first outer electrode. Each of the second inner electrode layers includes a second counter electrode portion, and a second extended portion protruding toward the second outer electrode. The first extended portion includes a first exposed portion exposed on the second principal surface. The second extended portion includes a second exposed portion exposed on the second principal surface. The first exposed portion located closest to the first side surface is convex toward the first side surface when viewed from the second principal surface. The first exposed portion located closest to the second side surface is convex toward the second side surface when viewed from the second principal surface. The second exposed portion located closest to the first side surface is convex toward the first side surface when viewed from the second principal surface. The second exposed portion located closest to the second side surface is convex toward the second side surface when viewed from the second principal surface.

In a multi-unit multilayer ceramic capacitor according to an example embodiment of the present invention, the multilayer body includes, inside the single element assembly, the plurality of capacitor units each including the plurality of dielectric layers and the plurality of inner electrode layers. The plurality of capacitor units are located at predetermined intervals in the length direction and the lamination direction. The inner electrode layers include the first inner electrode layers connected to the first outer electrode, and the second inner electrode layers connected to the second outer electrode. Each of the first inner electrode layers includes the first counter electrode portion, and the first extended portion protruding toward the first outer electrode. Each of the second inner electrode layers includes the second counter electrode portion, and the second extended portion protruding toward the second outer electrode. Thus, the current path can be shortened, and therefore ESL (Equivalent Series Inductance) can be reduced compared with a general two-terminal capacitor in which inner electrode layers are exposed on both end surfaces. In addition, the plurality of two-terminal capacitors can be replaced only with the multi-unit multilayer ceramic capacitor. Further, the number of capacitor units disposed inside the multilayer body of the multi-unit multilayer ceramic capacitor is adjusted depending on disposition of land electrodes. Therefore, the disposition of the land electrodes for the general two-terminal capacitors can be used as it is without changing design.

In a multi-unit multilayer ceramic capacitor according to an example embodiment of the present invention, each of the first inner electrode layers includes the first counter electrode portion, and the first extended portion protruding toward the first outer electrode. Each of the second inner electrode layers includes the second counter electrode portion, and the second extended portion protruding toward the second outer electrode. The first extended portion includes the first exposed portion exposed on the second principal surface. The second extended portion includes the second exposed portion exposed on the second principal surface. The first exposed portion located closest to the first side surface is convex toward the first side surface when viewed from the second principal surface. The first exposed portion located closest to the second side surface is convex toward the second side surface when viewed from the second principal surface. The second exposed portion located closest to the first side surface is convex toward the first side surface when viewed from the second principal surface. The second exposed portion located closest to the second side surface is convex toward the second side surface when viewed from the second principal surface. Therefore, the adhesion between the dielectric layer and the inner electrode layer can further be improved, and the structural defect, namely peeling, can be reduced or prevented.

According to example embodiments of the present invention, it is possible to provide multi-unit multilayer ceramic capacitors in each of which reduction in costs and improvement in yields are achieved and production efficiency is improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating a multi-unit multilayer ceramic capacitor according to an example embodiment of the present invention.

FIG. 2 is a bottom view illustrating an example of a multi-unit multilayer ceramic capacitor according to an example embodiment of the present invention.

FIG. 3 is a left-hand side view illustrating an example of a multi-unit multilayer ceramic capacitor according to an example embodiment of the present invention.

FIG. 4 is a schematic cross-sectional view taken along line IV-IV in FIG. 1.

FIG. 5 is a schematic cross-sectional view taken along line V-V in FIG. 1.

FIG. 6 is a schematic cross-sectional view taken along line VI-VI in FIG. 3.

FIG. 7 is a schematic cross-sectional view taken along line VII-VII in FIG. 3.

FIG. 8 is a see-through perspective view illustrating disposition of inner electrode layers inside a multilayer body of a multi-unit multilayer ceramic capacitor according to an example embodiment of the present invention.

FIG. 9 is a see-through perspective view illustrating disposition of exposed portions of the inner electrode layers inside a multilayer body of a multi-unit multilayer ceramic capacitor according to an example embodiment of the present invention.

FIG. 10A is an enlarged view of portion A in FIG. 9, and FIG. 10B is an enlarged view of portion B in FIG. 9.

FIG. 11 is an exploded perspective view of a multilayer body of a multi-unit multilayer ceramic capacitor according to an example embodiment of the present invention.

### DETAILED DESCRIPTION OF THE EXAMPLE EMBODIMENTS

Examples of multi-unit multilayer ceramic capacitors according to example embodiments of the present invention will be described.

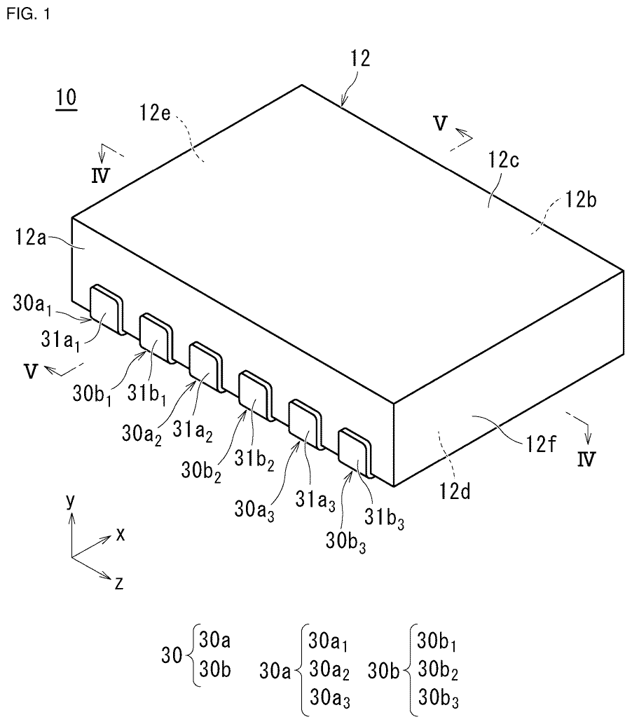

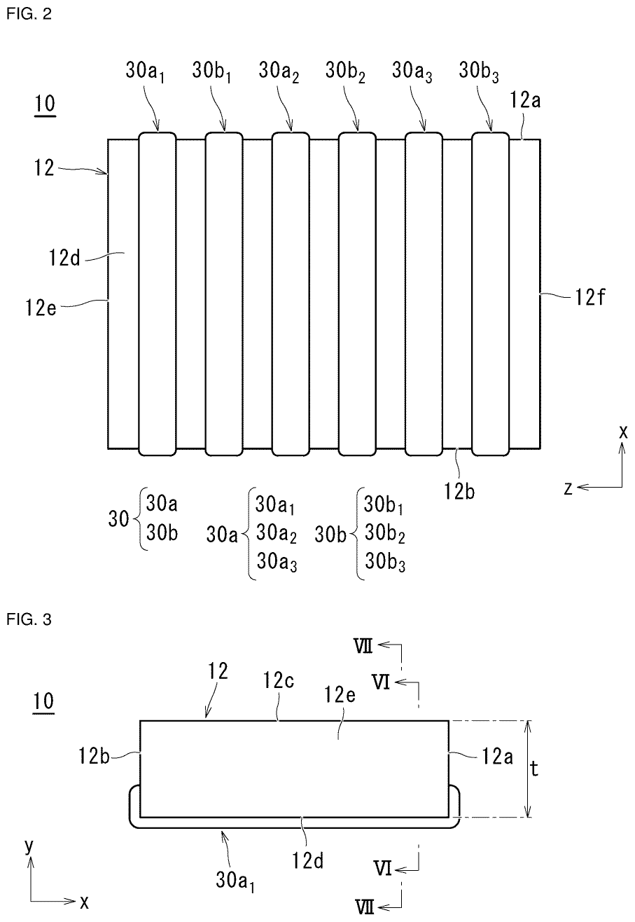

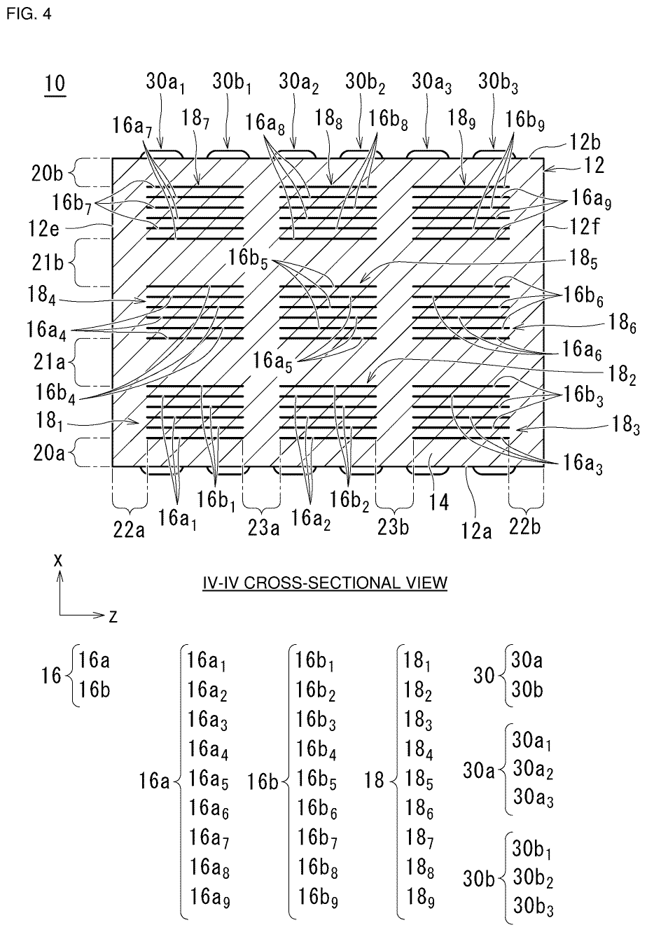

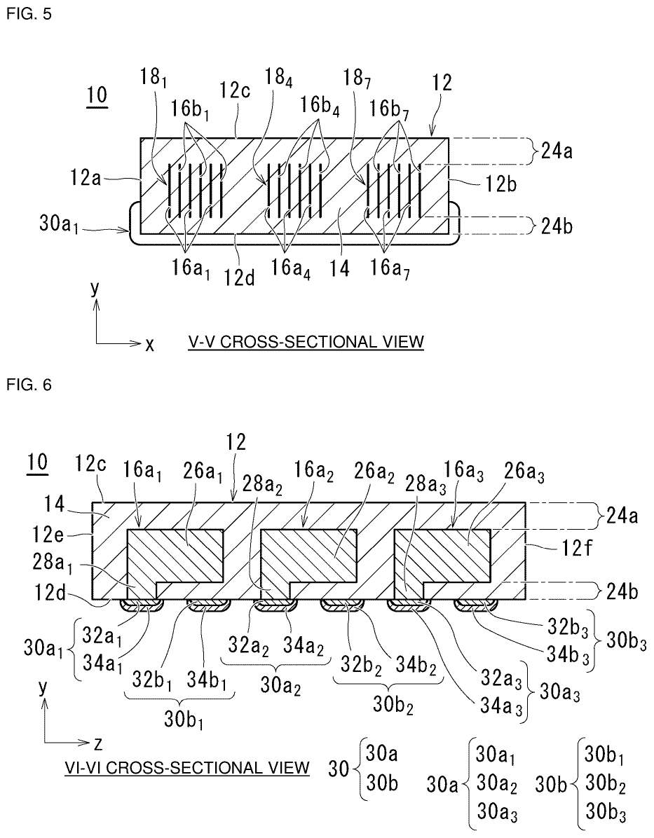

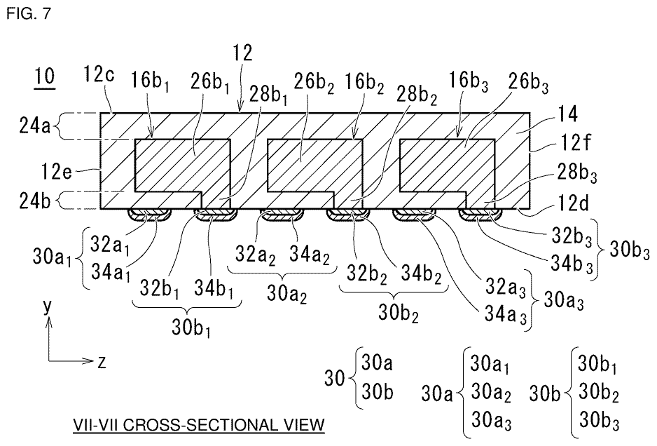

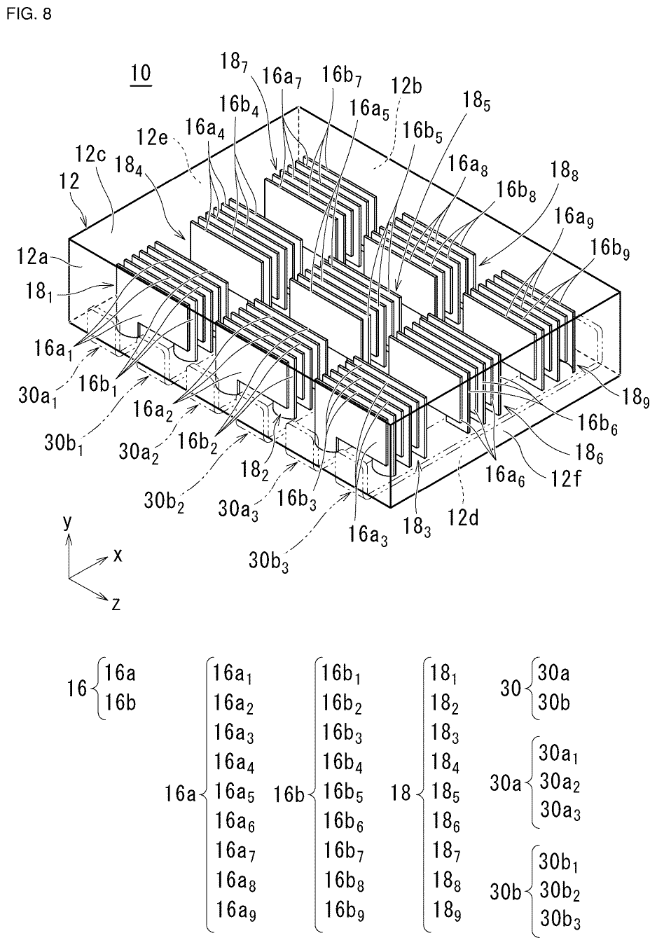

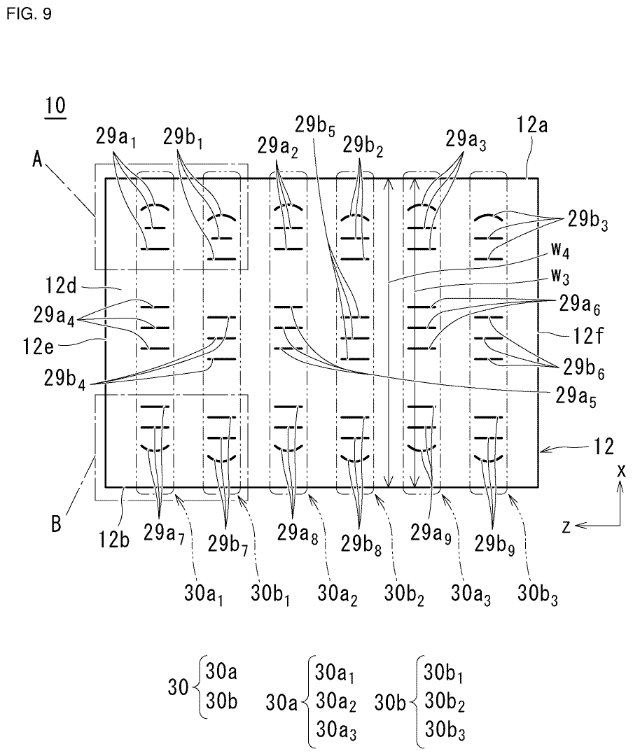

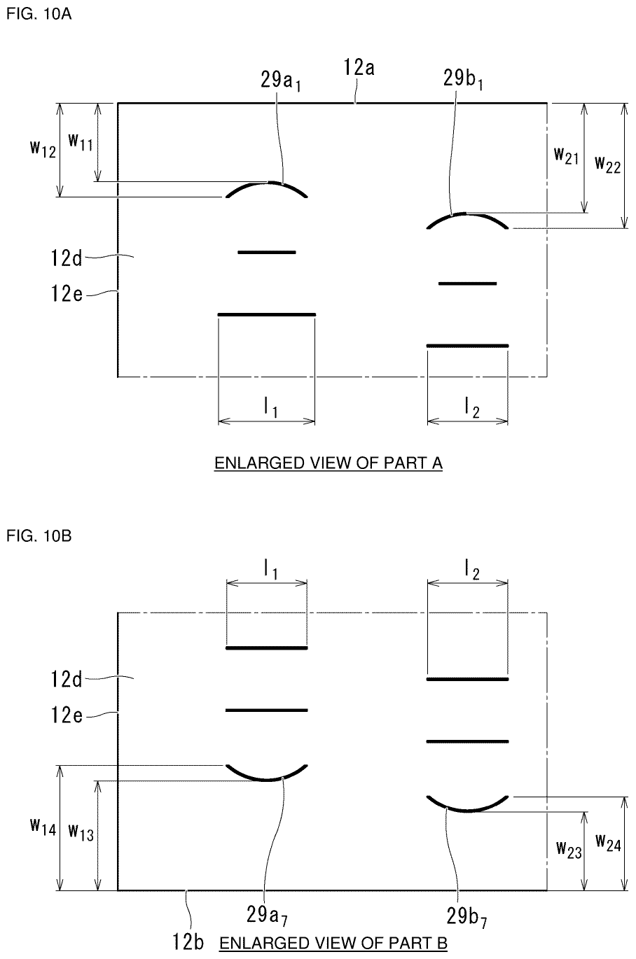

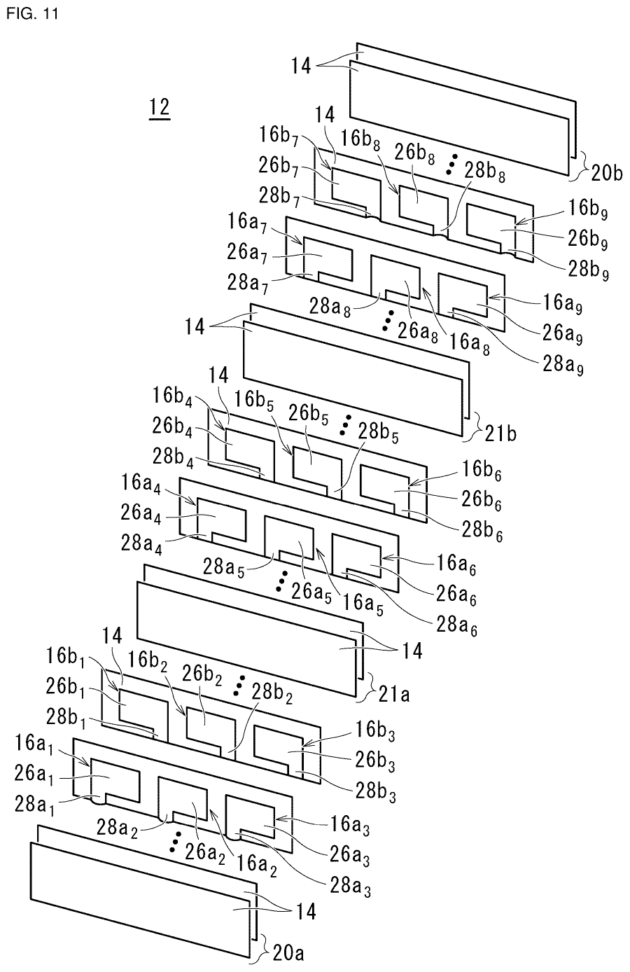

FIG. 1 is an external perspective view illustrating a multi-unit multilayer ceramic capacitor according to an example embodiment of the present invention. FIG. 2 is a bottom view illustrating an example of a multi-unit multilayer ceramic capacitor according to an example embodiment of the present invention. FIG. 3 is a left-hand side view illustrating an example of a multi-unit multilayer ceramic capacitor according to an example embodiment of the present invention. FIG. 4 is a schematic cross-sectional view taken along line IV-IV in FIG. 1. FIG. 5 is a schematic cross-sectional view taken along line V-V in FIG. 1. FIG. 6 is a schematic cross-sectional view taken along line VI-VI in FIG. 3. FIG. 7 is a schematic cross-sectional view taken along line VII-VII in FIG. 3. FIG. 8 is a see-through perspective view illustrating disposition of inner electrode layers inside a multilayer body of a multi-unit multilayer ceramic capacitor according to an example embodiment of the present invention. FIG. 9 is a see-through perspective view illustrating disposition of exposed portions of the inner electrode layers inside the multilayer body of a multi-unit multilayer ceramic capacitor according to an example embodiment of the present invention. FIG. 10A is an enlarged view of portion A in FIG. 9. FIG. 10B is an enlarged view of portion B in FIG. 9.

As illustrated in FIG. 1 and FIG. 2, the multi-unit multilayer ceramic capacitor 10 includes, for example, a multilayer body 12 and outer electrodes 30.

The multilayer body 12 includes a plurality of laminated dielectric layers 14 and a plurality of inner electrode layers 16 laminated on the dielectric layers 14. The inner electrode layers 16 include first inner electrode layers 16a and second inner electrodes layer 16b. Details of the first inner electrode layers 16a and the second inner electrode layers 16b are described later.

The multilayer body 12 includes a first side surface 12a and a second side surface 12b that face each other in a lamination direction x, a first principal surface 12c and a second principal surface 12d that face each other in a height direction y orthogonal to the lamination direction x, and a first end surface 12e and a second end surface 12f that face each other in a length direction z orthogonal to the lamination direction x and the height direction y. The second principal surface 12d is a surface close to a mounting surface.

The multilayer body 12 includes, inside a single element assembly, a capacitor unit 18 including a plurality of dielectric layers 14 and a plurality of inner electrode layers 16. Inside the multilayer body 12, a plurality of capacitor units 18 are located at predetermined intervals in the length direction z and the lamination direction x. In this example embodiment, the capacitor units 18 include nine capacitor units that are a first capacitor unit 18₁ to a ninth capacitor unit 18₉.

The capacitor units 18 are preferably positioned inside the multilayer body 12 so as to satisfy a condition of 1≤N≤12 and 2≤M≤12 or 2≤N≤12 and 1≤M≤12, provided that N capacitor units 18 are located at predetermined intervals in the length direction z and M capacitor units 18 are located at predetermined intervals in the lamination direction x.

The multilayer body 12 preferably has a rectangular or substantially rectangular parallelepiped shape. The corner portions and the ridge portions of the multilayer body 12 are preferably rounded. The corner portion is a portion where three surfaces of the multilayer body 12 intersect each other. The ridge portion is a portion where two surfaces of the multilayer body 12 intersect each other. A portion or all of the first side surface 12a and the second side surface 12b, the first principal surface 12c and the second principal surface 12d, and the first end surface 12e and the second end surface 12f may have irregularities, etc.

A dimension t of the multilayer body 12 in the height direction y is preferably about 1.00 mm or less, for example.

As illustrated in FIG. 4, the multilayer body 12 includes, in the lamination direction x, the plurality of capacitor units 18, a first outer layer portion 20a located between the first side surface 12a and the capacitor units 18 (18₁ to 18₃) closest to the first side surface 12a among the plurality of capacitor units 18, a second outer layer portion 20b located between the second side surface 12b and the capacitor units 18 (18₇ to 18₉) closest to the second side surface 12b among the plurality of capacitor units 18, and intermediate layers 21 located between the capacitor units 18. The intermediate layer 21 is about ten times or more as thick as the dielectric layer 14 of the capacitor unit 18, for example. In this example embodiment, the intermediate layers 21 include a first intermediate layer 21a located between the capacitor units 18₁ to 18₃ and the capacitor units 18₄ to 18₆, and a second intermediate layer 21b located between the capacitor units 18₄ to 18₆ and the capacitor units 18₇ to 18₉.

As illustrated in FIG. 4, the multilayer body 12 includes, in the length direction z, a first end gap 22a located between the capacitor units 18 (18₁, 18₄, 18₇) and the first end surface 12e, a second end gap 22b located between the capacitor units 18 (18₃, 18₆, 18₉) and the second end surface 12f, and intermediate gaps 23 located between the capacitor units 18. In this example embodiment, the intermediate gaps 23 include a first intermediate gap 23a located between the capacitor units 18₁, 18₄, 18₇ and the capacitor units 18₂, 18₅, 18₈, and a second intermediate gap 23b located between the capacitor units 18₂, 18₅, 18₈ and the capacitor units 18₃, 18₆, 18₉.

As illustrated in FIG. 5 to FIG. 7, the multilayer body 12 includes, in the height direction y, an upper region 24a located between the capacitor units 18 and the first principal surface 12c, and a lower region 24b located between the capacitor units 18 and the second principal surface 12d.

As illustrated in FIG. 4 and FIGS. 10A and 10B, the first outer layer portion 20a is located close to the first side surface 12a of the multilayer body 12, and is an aggregate of a plurality of dielectric layers 14 located between the first side surface 12a and the capacitor units 18 (18₁ to 18₃) closest to the first side surface 12a. The second outer layer portion 20b is located close to the second side surface 12b of the multilayer body 12, and is an aggregate of a plurality of dielectric layers 14 located between the second side surface 12b and the capacitor units 18 (18₇ to 18₉) closest to the second side surface 12b.

The dielectric layer 14 may be made of a ceramic material such as dielectric ceramics including BaTiO₃, CaTiO₃, SrTiO₃, or CaZrO₃ as a component. A material obtained by adding an auxiliary component such as a Mn compound, an Fe compound, a Cr compound, a Co compound, or a Ni compound to the main component may be used.

The thickness of the dielectric layer 14 is preferably about 0.3 μm or more and about 1.0 μm or less, for example. The number of laminated dielectric layers 14 of one capacitor unit 18 is preferably four or more and 1000 or less.

The inner electrode layers 16 include the first inner electrode layers 16a and the second inner electrode layers 16b.

As illustrated in FIG. 4 and FIG. 6, the first inner electrode layers 16a include a plurality of first inner electrode layers 16a₁ to 16a₃ of the first capacitor unit 18₁ to the third capacitor unit 18₃, a plurality of first inner electrode layers 16a₄ to 16a₆ of the fourth capacitor unit 18₄ to the sixth capacitor unit 18₆, and a plurality of first inner electrode layers 16a₇ to 16a₉ of the seventh capacitor unit 18₇ to the ninth capacitor unit 18₉. The first inner electrode layers 16a₁ to 16a₃ are disposed on the same dielectric layer 14. The first inner electrode layers 16a₄ to 16a₆ are disposed on the same dielectric layer 14. The first inner electrode layers 16a₇ to 16a₉ are disposed on the same dielectric layer 14. The first inner electrode layer 16a is extended to the second principal surface 12d.

The first inner electrode layers 16a are described in detail taking the first inner electrode layer 16a₁ as an example. As illustrated in FIG. 6, the first inner electrode layer 16a₁ includes a first counter electrode portion 26a₁ that faces a second inner electrode layer 16b₁, and a first extended portion 28a₁ that runs from the first counter electrode portion 26a₁ and is extended to the second principal surface 12d. The first extended portion 28a₁ is exposed on the second principal surface 12d of the multilayer body 12. The shape of the first counter electrode portion 26a₁ and the shape of the first extended portion 28a₁ are not particularly limited, but are each preferably a rectangular shape. The corner portion of the first counter electrode portion 26a₁ may be rounded.

The first inner electrode layers 16a₂ to 16a₉ have the same structure as the first inner electrode layer 16a₁.

As illustrated in FIG. 4 and FIG. 7, the second inner electrode layers 16b include a plurality of second inner electrode layers 16b₁ to 16b₃ of the first capacitor unit 18₁ to the third capacitor unit 18₃, a plurality of second inner electrode layers 16b₄ to 16b₆ of the fourth capacitor unit 18₄ to the sixth capacitor unit 18₆, and a plurality of second inner electrode layers 16b₇ to 16b₉ of the seventh capacitor unit 18₇ to the ninth capacitor unit 18₉. The second inner electrode layers 16b₁ to 16b₃ are disposed on the same dielectric layer 14. The second inner electrode layers 16b₄ to 16b₆ are disposed on the same dielectric layer 14. The second inner electrode layers 16b₇ to 16b₉ are disposed on the same dielectric layer 14. The second inner electrode layer 16b is extended to the second principal surface 12d.

The second inner electrode layers 16b are described in detail taking the second inner electrode layer 16b₁ as an example. As illustrated in FIG. 7, the second inner electrode layer 16b₁ includes a second counter electrode portion 26b₁ that faces the first inner electrode layer 16a₁, and a second extended portion 28b₁ that runs from the second counter electrode portion 26b₁ and is extended to the second principal surface 12d. The second extended portion 28b₁ is exposed on the second principal surface 12d of the multilayer body 12. The shape of the second counter electrode portion 26b₁ and the shape of the second extended portion 28b₁ are not particularly limited, but are each preferably a rectangular shape. The corner portion of the second counter electrode portion 26b₁ may be rounded.

The second inner electrode layers 16b₂ to 16b₉ have the same structure as the second inner electrode layer 16b₁.

The first extended portions 28a₁ to 28a₉ include first exposed portions 29a₁ to 29a₉ exposed on the second principal surface 12d.

The second extended portions 28b₁ to 28b₉ include second exposed portions 29b₁ to 29b₉ exposed on the second principal surface 12d.

As illustrated in FIG. 9, the first exposed portions 29a₁ to 29a₃ located closest to the first side surface 12a are convex toward the first side surface 12a when viewed from the second principal surface 12d.

As illustrated in FIG. 9, the first exposed portions 29a₇ to 29a₉ located closest to the second side surface 12b are convex toward the second side surface 12b when viewed from the second principal surface 12d.

With the above structure, the adhesion between the dielectric layer 14 and the inner electrode layer 16 can be improved, and a structural defect, namely peeling, can be reduced or prevented.

As illustrated in FIG. 9, the second exposed portions 29b₁ to 29b₃ located closest to the first side surface 12a are convex toward the first side surface 12a when viewed from the second principal surface 12d.

As illustrated in FIG. 9, the second exposed portions 29b₇ to 29b₉ located closest to the second side surface 12b are convex toward the second side surface 12b when viewed from the second principal surface 12d.

With the above structure, the adhesion between the dielectric layer 14 and the inner electrode layer 16 can be improved, and the structural defect, namely peeling, can be reduced or prevented.

As illustrated in FIG. 10A, a distance w₁₁ between the first side surface 12a and a central portion of the first exposed portion 29a₁ located closest to the first side surface 12a is smaller than a distance w₁₂ between the first side surface 12a and an end portion of the first exposed portion 29a₁ closest to the first side surface 12a. The same applies to the first exposed portions 29a₂ and 29a₃.

As illustrated in FIG. 10B, a distance w₁₃ between the second side surface 12b and a central portion of the first exposed portion 29a₇ located closest to the second side surface 12b is smaller than a distance w₁₄ between the second side surface 12b and an end portion of the first exposed portion 29a₇ closest to the second side surface 12b. The same applies to the first exposed portions 29a₈ and 29a₉.

With the above structure, the adhesion between the dielectric layer 14 and the inner electrode layer 16 can further be improved, and the structural defect, namely peeling, can be reduced or prevented.

As illustrated in FIG. 10A, a distance w₂₁ between the first side surface 12a and a central portion of the second exposed portion 29b₁ located closest to the first side surface 12a is smaller than a distance w₂₂ between the first side surface 12a and an end portion of the second exposed portion 29b₁ closest to the first side surface 12a. The same applies to the second exposed portions 29b₂ and 29b₃.

As illustrated in FIG. 10B, a distance w₂₃ between the second side surface 12b and a central portion of the second exposed portion 29b₇ located closest to the second side surface 12b is smaller than a distance W₂₄ between the second side surface 12b and an end portion of the second exposed portion 29b₇ closest to the second side surface 12b. The same applies to the second exposed portions 29b₈ and 29b₉.

With the above structure, the adhesion between the dielectric layer 14 and the inner electrode layer 16 can further be improved, and the structural defect, namely peeling, can be reduced or prevented.

As illustrated in FIGS. 10A and 10B, the first exposed portions 29a₁ to 29a₃ located closest to the first side surface 12a and the first exposed portions 29a₇ to 29a₉ closest to the second side surface 12b are exposed to be convex in opposite directions.

As illustrated in FIGS. 10A and 10B, the second exposed portions 29b₁ to 29b₃ located closest to the first side surface 12a and the second exposed portions 29b₇ to 29b₉ closest to the second side surface 12b are exposed to be convex in opposite directions.

As illustrated in FIGS. 10A and 10B, the ratio of the maximum length to the minimum length about a length l₁ in the length direction z for each of the first exposed portions 29a₁ to 29a₉ exposed from the second principal surface 12d is preferably about 1.0 or more and about 1.5 or less, for example. FIGS. 10A and 10B illustrate the first exposed portions 29a₁ and 29a₇ as examples.

As illustrated in FIGS. 10A and 10B, the ratio of the maximum length to the minimum length about a length l₂ in the length direction z for each of the second exposed portions 29b₁ to 29b₉ exposed from the second principal surface 12d is preferably about 1.0 or more and about 1.5 or less, for example. FIGS. 10A and 10B illustrate the second exposed portions 29b₁ and 29b₇ as examples.

With the above structure, the contact between the outer electrode 30 and the inner electrode layer 16 can be secured, and the impedance characteristics can be improved. With the above structure, the exposure of the inner electrode layer 16 from the outer electrode 30 can be avoided, and therefore the moisture resistance reliability can be secured.

The thickness of each of the first extended portions 28a₁ to 28a₉ and the second extended portions 28b₁ to 28b₉ is preferably about 0.2 μm or more and about 1.0 μm or less, for example.

With the above structure, the contact between the outer electrode 30 and the inner electrode layer 16 can be secured, and the impedance characteristics can further be improved.

As illustrated in FIG. 9, a dimension w₃ of the multilayer body 12 in the lamination direction x in a region where the first exposed portions 29a₁ to 29a₉ are located along the lamination direction x is larger than a dimension w₄ of the multilayer body 12 in the lamination direction x in a region where the first exposed portions 29a₁ to 29a₉ and the second exposed portion 29b₁ to 29b₉ are not located along the lamination direction x. The same applies to the second exposed portions 29b₁ to 29b₉.

With the above structure, the surfaces of the multilayer body 12 are wavy. When the multi-unit multilayer ceramic capacitor 10 is molded using a mold resin, the wavy structure exerts an anchor effect, and the fixing force of the mold resin to the multi-unit multilayer ceramic capacitor 10 can be improved.

In the first capacitor unit 18₁, the first counter electrode portion 26a₁ of the first inner electrode layer 16a₁ and the second counter electrode portion 26b₁ of the second inner electrode layer 16b₁ face each other. In this example embodiment, the first counter electrode portion 26a₁ of the first inner electrode layer 16a₁ and the second counter electrode portion 26b₁ of the second inner electrode layer 16b₁ face each other via the dielectric layer 14 to generate an electrostatic capacitance and exhibit capacitor characteristics.

The second to ninth capacitor units 18₂ to 18₉ have the same structure as the first capacitor unit 18₁ to exhibit capacitor characteristics.

A Sn layer is located between the dielectric layer 14 and each of the first inner electrode layer 16a and the second inner electrode layer 16b. Therefore, electric field concentration on the interface between the inner electrode layer 16 and the dielectric layer 14 can be reduced, leading to improvement in high-temperature load reliability.

Each of the first inner electrode layer 16a and the second inner electrode layer 16b can be made of any appropriate conductive material such as a metal as typified by Ni, Cu, Ag, Pd, or Au or an alloy including at least one of these metals as typified by Ag—Pd alloy.

The number of laminated first inner electrode layers 16a of one capacitor unit 18 is not particularly limited, but is preferably, for example, one or more and 250 or less. The number of laminated second inner electrode layers 16b of one capacitor unit 18 is not particularly limited, but is preferably, for example, one or more and 250 or less. Thus, the total number of laminated first inner electrode layers 16a and second inner electrode layers 16b of one capacitor unit 18 is preferably two or more and 500 or less, for example.

The thickness of the first inner electrode layer 16a is not particularly limited, but is preferably, for example, about 0.3 μm or more and about 1.0 μm or less. The thickness of the second inner electrode layer 16b is not particularly limited, but is preferably, for example, about 0.3 μm or more and about 1.0 μm or less.

With the structure of the inner electrode layer 16 that is extended toward the second principal surface 12d (toward the mounting surface), the current path can be shortened, and ESL (Equivalent Series Inductance) can be reduced compared with a general two-terminal capacitor in which inner electrode layers are exposed on both end surfaces.

The plurality of two-terminal capacitors can be replaced with the multi-unit multilayer ceramic capacitor 10 in which the plurality of capacitor units are provided in the multilayer body 12.

The outer electrodes 30 include first outer electrodes 30a and second outer electrodes 30b.

The first outer electrodes 30a include a plurality of first outer electrodes 30a₁ to 30a₃. The plurality of first outer electrodes 30a₁ to 30a₃ are disposed on the second principal surface 12d at predetermined intervals along the length direction z. The plurality of first outer electrodes 30a₁ to 30a₃ extend in the lamination direction x.

The first outer electrode 30a₁ is electrically connected to the first exposed portions 29a₁, 29a₄, and 29a₇ of the first inner electrode layers 16a₁, 16a₄, and 16a₇. The first outer electrode 30a₁ is disposed to cover the first exposed portions 29a₁, 29a₄, and 29a₇ of the first inner electrode layers 16a₁, 16a₄, and 16a₇ that are exposed on the second principal surface 12d. The first outer electrode 30a₁ may have first folded portions 31a₁ disposed also on a portion of the first side surface 12a and a portion of the second side surface 12b.

The first outer electrode 30a₂ is electrically connected to the first exposed portions 29a₂, 29a₅, and 29a₈ of the first inner electrode layers 16a₂, 16a₅, and 16a₈. The first outer electrode 30a₂ is disposed to cover the first exposed portions 29a₂, 29a₅, and 29a₈ of the first inner electrode layers 16a₂, 16a₅, and 16a₈ that are exposed on the second principal surface 12d. The first outer electrode 30a₂ may have first folded portions 31a₂ disposed also on a portion of the first side surface 12a and a portion of the second side surface 12b.

The first outer electrode 30a₃ is electrically connected to the first exposed portions 29a₃, 29a₆, and 29a₉ of the first inner electrode layers 16a₃, 16a₆, and 16a₉. The first outer electrode 30a₃ is disposed to cover the first exposed portions 29a₃, 29a₆, and 29a₉ of the first inner electrode layers 16a₃, 16a₆, and 16a₉ that are exposed on the second principal surface 12d. The first outer electrode 30a₃ may have first folded portions 31a₃ disposed also on a portion of the first side surface 12a and a portion of the second side surface 12b.

The second outer electrodes 30b include a plurality of second outer electrodes 30b₁ to 30b₃. The plurality of second outer electrodes 30b₁ to 30b₃ are disposed on the second principal surface 12d at predetermined intervals along the length direction z. The plurality of second outer electrodes 30b₁ to 30b₃ extend in the lamination direction x.

The second outer electrode 30b₁ is electrically connected to the second exposed portions 29b₁, 29b₄, and 29b₇ of the second inner electrode layers 16b₁, 16b₄, and 16b₇. The second outer electrode 30b₁ is disposed to cover the second exposed portions 29b₁, 29b₄, and 29b₇ of the second inner electrode layers 16b₁, 16b₄, and 16b₇ that are exposed on the second principal surface 12d. The second outer electrode 30b₁ may have second folded portions 31b₁ disposed also on a portion of the first side surface 12a and a portion of the second side surface 12b.

The second outer electrode 30b₂ is electrically connected to the second exposed portions 29b₂, 29b₅, and 29b₈ of the second inner electrode layers 16b₂, 16b₅, and 16b₈. The second outer electrode 30b₂ is disposed to cover the second exposed portions 29b₂, 29b₅, and 29b₈ of the second inner electrode layers 16b₂, 16b₅, and 16b₈ that are exposed on the second principal surface 12d. The second outer electrode 30b₂ may have second folded portions 31b₂ disposed also on a portion of the first side surface 12a and a portion of the second side surface 12b.

The second outer electrode 30b₃ is electrically connected to the second exposed portions 29b₃, 29b₆, and 29b₉ of the second inner electrode layers 16b₃, 16b₆, and 16b₉. The second outer electrode 30b₃ is disposed to cover the second exposed portions 29b₃, 29b₆, and 29b₉ of the second inner electrode layers 16b₃, 16b₆, and 16b₉ that are exposed on the second principal surface 12d. The second outer electrode 30b₃ may have second folded portions 31b₃ disposed also on a portion of the first side surface 12a and a portion of the second side surface 12b.

The outer electrodes 30 include underlying electrode layers 32 disposed on the surface of the multilayer body 12, and plating layers 34 disposed to cover the underlying electrode layers 32.

The underlying electrode layers 32 include first underlying electrode layers 32a and second underlying electrode layers 32b.

The plating layers 34 include first plating layers 34a and second plating layers 34b.

In other words, the first outer electrodes 30a include the first underlying electrode layers 32a and the first plating layers 34a. More specifically, the first outer electrodes 30a₁ to 30a₃ include first underlying electrode layers 32a₁ to 32a₃ and first plating layers 34a₁ to 34a₃.

The second outer electrodes 30b include the second underlying electrode layers 32b and the second plating layers 34b. More specifically, the second outer electrodes 30b₁ to 30b₃ include second underlying electrode layers 32b₁ to 32b₃ and second plating layers 34b₁ to 34b₃.

The first underlying electrode layers 32a₁ to 32a₃ are disposed on the second principal surface 12d of the multilayer body 12 and extend from the second principal surface 12d and cover a portion of the first side surface 12a and a portion of the second side surface 12b.

The second underlying electrode layers 32b₁ to 32b₃ are disposed on the second principal surface 12d of the multilayer body 12 and extend from the second principal surface 12d and cover a portion of the first side surface 12a and a portion of the second side surface 12b.

The underlying electrode layer 32 includes at least one selected from among a baked layer, a conductive resin layer, a thin film layer, etc.

Description is now made about each structure in the case where the underlying electrode layer 32 is the baked layer, the conductive resin layer, or the thin film layer described above.

The baked layer includes a glass component and a metal component. The glass component of the baked layer includes at least one selected from among B, Si, Ba, Mg, Al, Li, etc. The metal component of the baked layer includes at least one selected from among, for example, Cu, Ni, Ag, Pd, Ag—Pd alloy, and Au. The baked layer may be a plurality of layers. The baked layer is obtained by applying a conductive paste including the glass component and the metal component to the multilayer body 12 and baking the conductive paste. The baked layer may be obtained by simultaneously baking a multilayer chip including the inner electrode layers 16 and the dielectric layers 14 and a conductive paste applied to the multilayer chip, or may be obtained by baking a multilayer chip including the inner electrode layers 16 and the dielectric layers 14 to obtain the multilayer body 12, applying a conductive paste to the multilayer body 12, and baking the conductive paste. When the baked layer is obtained by simultaneously baking a multilayer chip including the inner electrode layers 16 and the dielectric layers 14 and a conductive paste applied to the multilayer chip, the baked layer is preferably formed by baking a material including a dielectric material added instead of the glass component.

In each of the first underlying electrode layers 32a₁ to 32a₃ located on the second principal surface 12d, the thickness in the height direction y connecting the first principal surface 12c and the second principal surface 12d is preferably about 10 μm or more and about 30 μm or less, for example.

In each of the second underlying electrode layers 32b₁ to 32b₃ located on the second principal surface 12d, the thickness in the height direction y connecting the first principal surface 12c and the second principal surface 12d is preferably about 10 μm or more and about 30 μm or less, for example.

In each of the first folded portions 31a₁ to 31a₃ of the first underlying electrode layers 32a₁ to 32a₃ located on a portion of the first side surface 12a and a portion of the second side surface 12b, the thickness in the lamination direction x connecting the first side surface 12a and the second side surface 12b at a central portion in the height direction y connecting the first principal surface 12c and the second principal surface 12d is preferably, for example, about 1 μm or more and about 20 μm or less.

In each of the second folded portions 31b₁ to 31b₃ of the second underlying electrode layers 32b₁ to 32b₃ located on a portion of the first side surface 12a and a portion of the second side surface 12b, the thickness in the lamination direction x connecting the first side surface 12a and the second side surface 12b at a central portion in the height direction y connecting the first principal surface 12c and the second principal surface 12d is preferably, for example, about 1 μm or more and about 20 μm or less.

The conductive resin layer may be disposed on a baked layer to cover the baked layer, or disposed directly on the multilayer body 12 without the baked layer. The conductive resin layer may completely cover the baked layer, or cover a portion of the baked layer. The conductive resin layer may be a plurality of layers.

The conductive resin layer includes a thermosetting resin and a metal. Since the conductive resin layer includes the thermosetting resin, the conductive resin layer has higher flexibility than, for example, a plating layer or a baked layer that is a baked product of a conductive paste. Therefore, when the multi-unit multilayer ceramic capacitor 10 receives a physical impact or an impact caused by a heat cycle, the conductive resin layer functions as a cushioning layer, and cracking of the multi-unit multilayer ceramic capacitor 10 can be prevented.

The metal included in the conductive resin layer may be Ag, Cu, Ni, Sn, Bi, or an alloy including any of these metals. A metal powder coated with Ag on its surface may be used. When the metal powder coated with Ag on its surface is used, the metal powder is preferably a powder of Cu, Ni, Sn, Bi, or an alloy thereof. The reasons why the conductive metal powder of Ag is used as the conductive metal are as follows. Ag is suitable as the electrode material because the specific resistance is lowest among the metals. Ag is not oxidized and weather resistance is high because Ag is the noble metal. An inexpensive base metal can be used while maintaining the above Ag characteristics.

The metal included in the conductive resin layer may be Cu or Ni subjected to antioxidation treatment. The metal included in the conductive resin layer may be a metal powder coated with Sn, Ni, or Cu on its surface. When the metal powder coated with Sn, Ni, or Cu on its surface is used, the metal powder is preferably a powder of Ag, Cu, Ni, Sn, Bi, or an alloy thereof.

The metal included in the conductive resin layer mainly provides conductivity to the conductive resin layer. Specifically, a conductive path is provided in the conductive resin layer by contact between conductive fillers.

The metal included in the conductive resin layer may have a spherical shape, a flat shape, etc., but is preferably a mixture of a spherical metal powder and a flat metal powder.

The resin in the conductive resin layer may be various known thermosetting resins such as an epoxy resin, a phenol resin, a urethane resin, a silicone resin, and a polyimide resin. Among others, the epoxy resin excellent in heat resistance, moisture resistance, adhesion, etc., is one of the most appropriate resins.

The conductive resin layer preferably includes a thermosetting resin and a curing agent. When the epoxy resin is used as the base resin, the curing agent for the epoxy resin may be various known compounds such as phenol-based, amine-based, acid anhydride-based, imidazole-based, activated ester-based, and amide-imide-based compounds.

The thickest portion of the conductive resin layer is preferably, for example, about 3 μm or more and about 20 μm or less.

When the thin film layer is provided as the underlying electrode layer 32, the thin film layer is a layer of about 1 μm or less, for example, with metal particles deposited by a thin film forming method such as sputtering or vapor deposition.

The plating layers 34 are disposed to cover the underlying electrode layers 32. The plating layers 34 include the first plating layers 34a and the second plating layers 34b.

The first plating layers 34a are disposed to cover the first underlying electrode layers 32a. More specifically, the first plating layers 34a₁ to 34a₃ are disposed to cover the first underlying electrode layers 32a₁ to 32a₃.

The second plating layers 34b are disposed to cover the second underlying electrode layers 32b. More specifically, the second plating layers 34b₁ to 34b₃ are disposed to cover the second underlying electrode layers 32b₁ to 32b₃.

Each of the first plating layer 34a and the second plating layer 34b includes at least one selected from among, for example, Cu, Ni, Sn, Ag, Pd, Ag—Pd alloy, and Au.

The plating layer 34 may be a plurality of layers. In this case, the plating layer 34 preferably has a two-layer structure including a lower plating layer on the underlying electrode layer 32 and plated with Ni, and an upper plating layer formed on the lower plating layer and plated with Sn.

That is, the first plating layer 34a includes a first lower plating layer and a first upper plating layer located on the surface of the first lower plating layer.

The second plating layer 34b includes a second lower plating layer and a second upper plating layer located on the surface of the second lower plating layer.

The lower plating layer plated with Ni is used for preventing the underlying electrode layer 32 from being corroded by solder when the multi-unit multilayer ceramic capacitor 10 is mounted. The upper plating layer plated with Sn is used for easily mounting the multi-unit multilayer ceramic capacitor 10 by improving the wettability of solder for mounting.

The thickness of one plating layer is preferably about 1 μm or more and about 10 μm or less, for example.

The dimension of the multi-unit multilayer ceramic capacitor 10 in the length direction z is a dimension L. The dimension L is preferably about 0.8 mm or more and about 14.4 mm or less, for example. The dimension L may be about 0.2 mm or more and about 20.0 mm or less, for example.

The dimension of the multi-unit multilayer ceramic capacitor 10 in the height direction y is a dimension T. The dimension T is preferably about 0.5 mm or more and about 0.8 mm or less, for example. The dimension T may be about 0.2 mm or more and about 1.0 mm or less, for example.

The dimension of the multi-unit multilayer ceramic capacitor 10 in the lamination direction x is a dimension W. The dimension W is preferably about 0.4 mm or more and about 7.8 mm or less, for example. The dimension W may be about 0.2 mm or more and about 20.0 mm or less, for example.

In the multi-unit multilayer ceramic capacitor 10 illustrated in FIG. 1, the inner electrode layer 16 is disposed to be exposed only on the second principal surface 12d that is the surface close to the mounting surface. Thus, the current path can be shortened, and therefore ESL (Equivalent Series Inductance) can be reduced compared with a general two-terminal capacitor in which inner electrode layers are exposed on both end surfaces.

In the multi-unit multilayer ceramic capacitor 10 illustrated in FIG. 1, the multilayer body 12 includes, inside the single element assembly, the capacitor unit 18 including the plurality of dielectric layers 14 and the plurality of inner electrode layers 16. Inside the multilayer body 12, the plurality of capacitor units 18 are located at predetermined intervals in the length direction z and the lamination direction x. Thus, the plurality of two-terminal capacitors can be replaced only with the multi-unit multilayer ceramic capacitor 10.

In the multi-unit multilayer ceramic capacitor 10 illustrated in FIG. 1, the number of capacitor units 18 disposed inside the multilayer body 12 of the multi-unit multilayer ceramic capacitor 10 is adjusted depending on disposition of land electrodes. Therefore, the disposition of the land electrodes for the general two-terminal capacitors can be used as it is without changing design.

In the multi-unit multilayer ceramic capacitor 10 illustrated in FIG. 1, the first exposed portions 29a₁ to 29a₃ located closest to the first side surface 12a are convex toward the first side surface 12a when viewed from the second principal surface 12d, and the first exposed portions 29a₇ to 29a₉ located closest to the second side surface 12b are convex toward the second side surface 12b when viewed from the second principal surface 12d. The second exposed portions 29b₁ to 29b₃ located closest to the first side surface 12a are convex toward the first side surface 12a when viewed from the second principal surface 12d, and the second exposed portions 29b₇ to 29b₉ located closest to the second side surface 12b are convex toward the second side surface 12b when viewed from the second principal surface 12d. Thus, the adhesion between the dielectric layer 14 and the inner electrode layer 16 can be improved, and the structural defect, namely peeling, can be reduced or prevented.

Next, a non-limiting example of a method for manufacturing the multi-unit multilayer ceramic capacitor is described. A non-limiting example of a method for manufacturing the multi-unit multilayer ceramic capacitor 10 is described below.

First, dielectric sheets for dielectric layers and conductive pastes for inner electrodes are prepared. The dielectric sheets and the conductive pastes for inner electrodes contain binders and solvents. Known binders and solvents may be used.

Next, the conductive pastes for inner electrodes are printed on the dielectric sheets in predetermined patterns by, for example, screen printing or gravure printing. Thus, dielectric sheets with the pattern of the first inner electrode layers and dielectric sheets with the pattern of the second inner electrode layers are prepared.

A portion serving as the plurality of capacitor units is formed by alternately laminating the dielectric sheets printed with the first inner electrode layers and the dielectric sheets printed with the second inner electrode layers to obtain a desired structure.

Next, a portion serving as the first outer layer portion 20a close to the first side surface 12a is formed by laminating a predetermined number of dielectric sheets not printed with the patterns of the inner electrode layers. Then, the portion serving as the plurality of capacitor units 18 formed in the above step is laminated on the portion serving as the first outer layer portion 20a. Next, the intermediate layer 21 is formed by laminating a predetermined number of dielectric sheets not printed with the patterns of the inner electrode layers on the portion serving as the plurality of capacitor units 18. Then, a portion serving as a plurality of other capacitor units 18 formed in the above step is laminated on the intermediate layer 21. The layer including the capacitor units 18 and the intermediate layer 21 are repeatedly formed a predetermined number of times. Lastly, the second outer layer portion 20b close to the second side surface 12b is formed by laminating a predetermined number of dielectric sheets not printed with the patterns of the inner electrode layers on the portion serving as the plurality of capacitor units 18. Thus, a multilayer sheet is produced.

Next, a multilayer block of the multi-unit multilayer ceramic capacitor is produced by pressing the multilayer sheet in the lamination direction by isostatic pressing, etc. At this time, the first exposed portions located closest to the first side surface 12a are formed to become convex toward the first side surface 12a when viewed from the second principal surface 12d, and the first exposed portions located closest to the second side surface 12b are formed to become convex toward the second side surface 12b when viewed from the second principal surface 12d. The second exposed portions located closest to the first side surface 12a are formed to become convex toward the first side surface 12a when viewed from the second principal surface 12d, and the second exposed portions located closest to the second side surface 12b are formed to become convex toward the second side surface 12b when viewed from the second principal surface 12d.

Next, the multilayer block is cut to a predetermined size, and therefore a multilayer chip is cut out. At this time, the corner portions and the ridge portions of the multilayer chip may be rounded by barrel finishing, etc.

The multilayer body 12 is produced by baking the multilayer chip thus cut out. The baking temperature is preferably about 900° C. or more and about 1400° C. or less, for example, depending on the materials of the dielectric layers 14 and the inner electrode layers 16.

Next, the first underlying electrode layers 32a of the plurality of first outer electrodes 30a and the second underlying electrode layers 32b of the plurality of second outer electrodes 30b are formed on the second principal surface 12d of the multilayer body 12 obtained by baking.

When a baked layer is formed as the underlying electrode layer 32, a conductive paste including a glass component and a metal component is applied and then baked. Thus, the baked layer is formed as the underlying electrode layer 32. At this time, the baking temperature is preferably about 700° C. or more and about 900° C. or less, for example. In this example embodiment, the underlying electrode layer 32 is the baked layer.

Various methods may be used as the method for forming the baked layer. For example, there may be used a method in which the direction of the multilayer body 12 is adjusted using a camera or magnet such that the second principal surface 12d is oriented downward, the multilayer body 12 is then held by a holding jig, and the conductive paste is applied by being ejected from a slit or hole. In the case of this method, the underlying electrode layer 32 can be formed not only on the second principal surface 12d but also up to a portion of the first side surface 12a and a portion of the second side surface 12b by increasing the ejection amount of the conductive paste.

A roller transfer method may be used for formation. When the underlying electrode layer 32 is formed not only on the second principal surface 12d but also up to a portion of the first side surface 12a and a portion of the second side surface 12b by the roller transfer method, the underlying electrode layer 32 can be formed up to a portion of the first side surface 12a and a portion of the second side surface 12b by increasing the pushing pressure during the roller transfer.

When a conductive resin layer is formed as the underlying electrode layer 32, the conductive resin layer can be formed by the following method. The conductive resin layer may be formed on the surface of a baked layer, or the conductive resin layer alone may be formed directly on the multilayer body 12 without the baked layer.

As the method for forming the conductive resin layer, a conductive resin paste including a thermosetting resin and a metal component is applied to the baked layer or the multilayer body 12, and the resin is thermally cured by heat treatment at a temperature of about 250° C. or more and about 550° C. or less, for example. Thus, the conductive resin layer is formed. At this time, the atmosphere during the heat treatment is preferably a N₂ atmosphere. To prevent scattering of the resin and prevent oxidation of various metal components, the oxygen concentration is preferably about 100 ppm or less, for example.

The method for applying the conductive resin paste may be, for example, a method in which the conductive resin paste is applied by being ejected from a slit, as in the method for forming the baked layer as the underlying electrode layer 32.

When a thin film layer is formed as the underlying electrode layer 32, the underlying electrode layer 32 can be formed by carrying out masking etc. and a thin film forming method such as sputtering or vapor deposition at the location where the outer electrode 30 is to be formed. The underlying electrode layer 32 formed from the thin film layer is a layer of about 1 μm or less with metal particles deposited, for example.

Lastly, the plating layers 34 are formed. The plating layers 34 are formed on the surfaces of the underlying electrode layers 32. More specifically, a nickel plating layer serving as a lower plating layer and a tin plating layer serving as an upper plating layer are formed on the underlying electrode layer 32. The plating may be either electrolytic plating or non-electrolytic plating. However, the non-electrolytic plating is disadvantageous in that pretreatment using a catalyst etc. is required to improve the plating precipitation rate, thereby complicating the steps. Thus, the electrolytic plating is preferably used in general.

In the manner described above, the multi-unit multilayer ceramic capacitor 10 according to this example embodiment is manufactured.

To check the effects of a multi-unit multilayer ceramic capacitor according to an example embodiment of the present invention, an experiment for checking whether the structural defect occurred and checking the impedance characteristics was conducted by producing samples changed in length between the inner electrode layer and the side surface of the multilayer body and samples changed in thickness and length of the extended portion as experimental samples based on the above manufacturing method.

Multi-unit multilayer ceramic capacitors were produced using the manufacturing method according to the present example embodiment.
Number of capacitor units included in multi-unit multilayer ceramic capacitor (N×M): 2×2
Dimension of multi-unit multilayer ceramic capacitor in length direction: 2.25 mm
Dimension of multi-unit multilayer ceramic capacitor in lamination direction: 1.25 mm
Dimension of multi-unit multilayer ceramic capacitor in height direction: 0.45 mm
Thickness of dielectric layer: 0.50 μm
Thickness of inner electrode layer: 0.50 μm
Number of laminated layers: 400

Whether the structural defect occurred was checked on each produced sample. For the check, a digital microscope manufactured by Keyence Corporation (VHX-5000, VHX-8000) was used.

The number of products was 100 for each sample. When the structural defect occurred in any one of the 100 products, determination was made as “unsatisfactory.”

In Sample Number 1, the relationship of the distance w₁₁ between the first side surface 12a and the central portion of the first exposed portion 29a₁ located closest to the first side surface 12a with the distance w₁₂ between the first side surface 12a and the end portion of the first exposed portion 29a₁ closest to the first side surface 12a was w₁₁<w₁₂. In Sample Number 2, the relationship was w₁₁≥w₁₂.

In each sample, the thickness of the extended portion was fixed to 0.5 μm.

In each sample, the ratio of the maximum length to the minimum length of the extended portion in the length direction was fixed to 1.2.

The relationship of the dimension w₃ of the multilayer body 12 in the lamination direction x in the region where the first exposed portions 29a₁ were located along the lamination direction x with the dimension w₄ of the multilayer body 12 in the lamination direction x in the region where the first exposed portions 29a₁ were not located along the lamination direction x was w₃>w₄.

In Sample Number 3, the relationship of the dimension w₃ of the multilayer body 12 in the lamination direction x in the region where the first exposed portions 29a₁ were located along the lamination direction x with the dimension w₄ of the multilayer body 12 in the lamination direction x in the region where the first exposed portions 29a₁ were not located along the lamination direction x was w₃>w₄. In Sample Number 4, the relationship was w₃≤w₄.

In each sample, the thickness of the extended portion was fixed to about 0.5 μm, for example.

In each sample, the ratio of the maximum length to the minimum length of the extended portion in the length direction was fixed to about 1.2. for example.

The relationship of the distance w₁₁ between the first side surface 12a and the central portion of the first exposed portion 29a₁ located closest to the first side surface 12a with the distance w₁₂ between the first side surface 12a and the end portion of the first exposed portion 29a₁ closest to the first side surface 12a was w₁₁<w₁₂.

Table 1 shows results of the check on the structural defect in relation to the difference in length between the inner electrode layer and the side surface of the multilayer body.

Table 2 shows results of the check on the structural defect in relation to the difference between the dimension of the multilayer body in the lamination direction in the region where the exposed portions are located and the dimension of the multilayer body in the lamination direction in the region where the exposed portions are not located.

TABLE 1

| | Relationship of distance w₁₁ between | |
|---|---|---|
| | first side surface and central | |
| | portion of first exposed portion with | |
| | distance w₁₂ between first side | |
| | surface and end portion of first | |
| Sample | exposed portion closest to first side | Structural |
| number | surface | defect |
| 1 | W₁₁ < W₁₂ | ○ |
| 2 | W₁₁ ≥ W₁₂ | × |

TABLE 2

| | Relationship of dimension w3 of | |
|---|---|---|
| | multilayer body in lamination | |
| | direction x in region where first | |
| | exposed portions are located with | |
| | dimension w4 of multilayer body in | |
| | lamination direction x in region | |
| Sample | where first exposed portions are | Structural |
| number | not located | defect |
| 3 | W₃ > W₄ | ○ |
| 4 | W₃ ≤ W₄ | × |

According to Table 1, in the sample of Sample Number 1, the relationship of the distance w₁₁ between the first side surface 12a and the central portion of the first exposed portion 29a₁ located closest to the first side surface 12a with the distance w₁₂ between the first side surface 12a and the end portion of the first exposed portion 29a₁ closest to the first side surface 12a was w₁₁<w₁₂. Therefore, the adhesion between the dielectric layer and the inner electrode layer was satisfactory, and no structural defect was observed.

In the sample of Sample Number 2, the relationship of the distance w₁₁ between the first side surface 12a and the central portion of the first exposed portion 29a₁ located closest to the first side surface 12a with the distance w₁₂ between the first side surface 12a and the end portion of the first exposed portion 29a₁ closest to the first side surface 12a was w₁₁≥w₁₂. Therefore, the adhesion between the dielectric layer and the inner electrode layer was unsatisfactory, and the structural defect was observed.

According to Table 2, in the sample of Sample Number 3, the relationship of the dimension w₃ of the multilayer body 12 in the lamination direction x in the region where the first exposed portions 29a₁ were located along the lamination direction x with the dimension w₄ of the multilayer body 12 in the lamination direction x in the region where the first exposed portions 29a₁ were not located along the lamination direction x was w₃>w₄. Therefore, the adhesion between the dielectric layer and the inner electrode layer was satisfactory, and no structural defect was observed.

In the sample of Sample Number 4, the relationship of the dimension w₃ of the multilayer body 12 in the lamination direction x in the region where the first exposed portions 29a₁ were located along the lamination direction x with the dimension w₄ of the multilayer body 12 in the lamination direction x in the region where the first exposed portions 29a₁ were not located along the lamination direction x was w₃≤w₄. Therefore, the adhesion between the dielectric layer and the inner electrode layer was unsatisfactory, and the structural defect was observed.

Each sample was mounted on a board. For the check, a network analyzer manufactured by Keyence Corporation (E5080A) was used.

When the impedance of a single capacitor unit at 100 MHz and 1 GHz was equal to or smaller than the equivalent of a multilayer ceramic capacitor with the same size and the same capacitance for one capacitor unit, determination was made as “satisfactory.”

When the impedance of a single capacitor unit at 100 MHz and 1 GHz was larger than the equivalent of a multilayer ceramic capacitor with the same size and the same capacitance for one capacitor unit, determination was made as “unsatisfactory.”

The number of products was ten for each sample.

In Sample Number 5 to Sample Number 7, the thicknesses of the extended portions of the inner electrode layers of the prepared samples were 0.1 μm, 0.2 μm, and 1.0 μm.

The relationship of the distance w₁₁ between the first side surface 12a and the central portion of the first exposed portion 29a₁ located closest to the first side surface 12a with the distance w₁₂ between the first side surface 12a and the end portion of the first exposed portion 29a₁ closest to the first side surface 12a was w₁₁<w₁₂.

The relationship of the dimension w₃ of the multilayer body 12 in the lamination direction x in the region where the first exposed portions 29a₁ were located along the lamination direction x with the dimension w₄ of the multilayer body 12 in the lamination direction x in the region where the first exposed portions 29a₁ were not located along the lamination direction x was w₃>w₄.

In each sample, the ratio of the maximum length to the minimum length of the extended portion in the length direction was fixed to 1.2.

In Sample Number 8 to Sample Number 11, the ratios of the maximum lengths to the minimum lengths about the lengths l₁ of the exposed portions of the inner electrode layers of the prepared samples in the length direction were 1.0, 1.5, 1.7, and 1.9.

The relationship of the distance w₁₁ between the first side surface 12a and the central portion of the first exposed portion 29a₁ located closest to the first side surface 12a with the distance w₁₂ between the first side surface 12a and the end portion of the first exposed portion 29a₁ closest to the first side surface 12a was w₁₁<w₁₂.

The relationship of the dimension w₃ of the multilayer body 12 in the lamination direction x in the region where the first exposed portions 29a₁ were located along the lamination direction x with the dimension w₄ of the multilayer body 12 in the lamination direction x in the region where the first exposed portions 29a₁ were not located along the lamination direction x was w₃>w₄.

The thickness of the extended portion was fixed to 0.5 μm.

Table 3 shows results of the measurement of the impedance characteristics in relation to the change in thickness of the extended portion of the inner electrode layer. Table 4 shows results of the measurement of the impedance characteristics in relation to the change in ratio of the maximum length to the minimum length about the length l₁ of the extended portion of the inner electrode layer.

TABLE 3

| Sample | Thickness of extended | Impedance |
|---|---|---|
| number | portion (μm) | characteristics |
| 5 | 0.1 | × |
| 6 | 0.2 | ○ |
| 7 | 1.0 | ○ |

TABLE 4

| | Ratio of maximum length | |
|---|---|---|
| | to minimum length about | |
| Sample | length I₁ of extended portion | Impedance |
| number | of internal electrode layer | characteristics |
| 8 | 1.0 | ○ |
| 9 | 1.5 | ○ |
| 10 | 1.7 | × |
| 11 | 1.9 | × |

According to Table 3, in the sample of Sample Number 5, the thickness of the extended portion of the inner electrode layer was 0.1 μm. Therefore, the contact between the outer electrode and the inner electrode layer was not secured, and the impedance characteristics were larger than the equivalent of a multilayer ceramic capacitor with the same size and the same capacitance for one capacitor unit.

In the samples of Sample Number 6 and Sample Number 7, the thicknesses of the extended portions of the inner electrode layers were 0.2 μm and 1.0 μm. Therefore, the contact between the outer electrode and the inner electrode layer was secured, and the impedance characteristics were equal to or smaller than the equivalent of a multilayer ceramic capacitor with the same size and the same capacitance for one capacitor unit.

According to Table 4, in the samples of Sample Number 8 and Sample Number 9, the ratios of the maximum lengths to the minimum lengths about the lengths l₁ of the extended portions of the inner electrode layers were 1.0 and 1.5. Therefore, the contact between the outer electrode and the inner electrode layer was secured, and the impedance characteristics were equal to or smaller than the equivalent of a multilayer ceramic capacitor with the same size and the same capacitance for one capacitor unit.

In the samples of Sample Number 10 and Sample Number 11, the ratios of the maximum lengths to the minimum lengths about the lengths l₁ of the extended portions of the inner electrode layers were about 1.7 and about 1.9, for example. Therefore, the variations in length l₁ of the extended portion increased. Thus, the contact between the outer electrode and the inner electrode layer was not secured, and the impedance characteristics were larger than the equivalent of a multilayer ceramic capacitor with the same size and the same capacitance for one capacitor unit.

Although example embodiments of the present invention are disclosed in the above description, the present invention is not limited thereto.

That is, various modifications may be made to the example embodiments in terms of mechanisms, shapes, materials, quantities, positions, disposition, etc., without departing from the technical ideas of example embodiments of the present invention, and such modifications are encompassed by the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multi-unit multilayer ceramic capacitor comprising:
a multilayer body including a first side surface and a second side surface that face each other in a lamination direction, a first principal surface and a second principal surface that face each other in a height direction orthogonal to the lamination direction, and a first end surface and a second end surface that face each other in a length direction orthogonal to both the lamination direction and the height direction;
a first outer electrode extending in the lamination direction on the second principal surface; and
a second outer electrode extending in the lamination direction on the second principal surface; wherein
the multilayer body includes, inside a single element assembly, a plurality of capacitor units each including a plurality of dielectric layers and a plurality of inner electrode layers, the plurality of capacitor units being located at predetermined intervals in the length direction and the lamination direction;
the inner electrode layers include:
first inner electrode layers connected to the first outer electrode; and
second inner electrode layers connected to the second outer electrode;
each of the first inner electrode layers includes:
a first counter electrode portion; and
a first extended portion protruding toward the first outer electrode;
each of the second inner electrode layers includes:
a second counter electrode portion; and
a second extended portion protruding toward the second outer electrode;
the first extended portion includes a first exposed portion exposed on the second principal surface;
the second extended portion includes a second exposed portion exposed on the second principal surface;
the first exposed portion located closest to the first side surface is convex toward the first side surface when viewed from the second principal surface;
the first exposed portion located closest to the second side surface is convex toward the second side surface when viewed from the second principal surface;
the second exposed portion located closest to the first side surface is convex toward the first side surface when viewed from the second principal surface; and
the second exposed portion located closest to the second side surface is convex toward the second side surface when viewed from the second principal surface.

2. The multi-unit multilayer ceramic capacitor according to claim 1, wherein
the first exposed portion located closest to the first side surface and the first exposed portion located closest to the second side surface are convex in opposite directions; and
the second exposed portion located closest to the first side surface and the second exposed portion located closest to the second side surface are convex in opposite directions.

3. The multi-unit multilayer ceramic capacitor according to claim 1, wherein
a ratio of a maximum length of the first exposed portion in the length direction to a minimum length of the first exposed portion in the length direction is about 1.0 or more and about 1.5 or less; and
a ratio of a maximum length of the second exposed portion in the length direction to a minimum length of the second exposed portion in the length direction is about 1.0 or more and about 1.5 or less.

4. The multi-unit multilayer ceramic capacitor according to claim 1, wherein a thickness of each of the first extended portion and the second extended portion is about 0.2 μm or more and about 1.0 μm or less.

5. The multi-unit multilayer ceramic capacitor according to claim 1, wherein
a dimension of the multilayer body in the lamination direction in a region where the first exposed portion is located is larger than a dimension of the multilayer body in the lamination direction in a region where the first exposed portion is not located; and
a dimension of the multilayer body in the lamination direction in a region where the second exposed portion is located is larger than a dimension of the multilayer body in the lamination direction in a region where the second exposed portion is not located.

6. The multi-unit multilayer ceramic capacitor according to claim 1, wherein
the multilayer body includes the plurality of capacitor units such that N capacitor units are positioned at the predetermined intervals in the length direction and M capacitor units are positioned at the predetermined intervals in the lamination direction; and
one of the following conditions is satisfied:
$$1 \leq N \leq 12 and 2 \leq M \leq 12 ; and$$
$$2 \leq N \leq 12 and 1 \leq M \leq 12 .$$

7. The multi-unit multilayer ceramic capacitor according to claim 1, wherein a dimension of the multilayer body in the height direction is about 1.00 mm or less.

8. The multi-unit multilayer ceramic capacitor according to claim 1, wherein a dimension of the multilayer body in the length direction is about 0.2 mm or more and about 20.0 mm or less.

9. The multi-unit multilayer ceramic capacitor according to claim 1, wherein a dimension of the multilayer body in the height direction is about 0.2 mm or more and about 1.0 mm or less.

10. The multi-unit multilayer ceramic capacitor according to claim 1, wherein a dimension of the multilayer body in the width direction is about 0.2 mm or more and about 20.0 mm or less.

11. A multi-unit multilayer ceramic capacitor comprising:
a multilayer body including a first side surface and a second side surface that face each other in a lamination direction, a first principal surface and a second principal surface that face each other in a height direction orthogonal to the lamination direction, and a first end surface and a second end surface that face each other in a length direction orthogonal to both the lamination direction and the height direction;
a first outer electrode extending in the lamination direction on the second principal surface; and
a second outer electrode extending in the lamination direction on the second principal surface; wherein
the multilayer body includes, inside a single element assembly, a plurality of capacitor units each including a plurality of dielectric layers and a plurality of inner electrode layers, the plurality of capacitor units being located at predetermined intervals in the length direction and the lamination direction;
the inner electrode layers include:
first inner electrode layers connected to the first outer electrode; and
second inner electrode layers connected to the second outer electrode;
each of the first inner electrode layers includes:
a first counter electrode portion; and
a first extended portion protruding toward the first outer electrode;
each of the second inner electrode layers includes:
a second counter electrode portion; and
a second extended portion protruding toward the second outer electrode;
a distance between the first side surface and a central portion of the first exposed portion located closest to the first side surface is smaller than a distance between the first side surface and an end portion of the first exposed portion located closest to the first side surface;
a distance between the second side surface and a central portion of the first exposed portion located closest to the second side surface is smaller than a distance between the second side surface and an end portion of the first exposed portion located closest to the second side surface;
a distance between the first side surface and a central portion of the second exposed portion located closest to the first side surface is smaller than a distance between the first side surface and an end portion of the second exposed portion located closest to the first side surface; and
a distance between the second side surface and a central portion of the second exposed portion located closest to the second side surface is smaller than a distance between the second side surface and an end portion of the second exposed portion located closest to the second side surface.

12. The multi-unit multilayer ceramic capacitor according to claim 11, wherein
the first exposed portion located closest to the first side surface and the first exposed portion located closest to the second side surface are convex in opposite directions; and
the second exposed portion located closest to the first side surface and the second exposed portion located closest to the second side surface are convex in opposite directions.

13. The multi-unit multilayer ceramic capacitor according to claim 11, wherein
a ratio of a maximum length of the first exposed portion in the length direction to a minimum length of the first exposed portion in the length direction is about 1.0 or more and about 1.5 or less; and
a ratio of a maximum length of the second exposed portion in the length direction to a minimum length of the second exposed portion in the length direction is about 1.0 or more and about 1.5 or less.

14. The multi-unit multilayer ceramic capacitor according to claim 11, wherein a thickness of each of the first extended portion and the second extended portion is about 0.2 μm or more and about 1.0 μm or less.

15. The multi-unit multilayer ceramic capacitor according to claim 11, wherein
a dimension of the multilayer body in the lamination direction in a region where the first exposed portion is located is larger than a dimension of the multilayer body in the lamination direction in a region where the first exposed portion is not located; and
a dimension of the multilayer body in the lamination direction in a region where the second exposed portion is located is larger than a dimension of the multilayer body in the lamination direction in a region where the second exposed portion is not located.

16. The multi-unit multilayer ceramic capacitor according to claim 11, wherein
the multilayer body includes the plurality of capacitor units such that N capacitor units are positioned at the predetermined intervals in the length direction and M capacitor units are positioned at the predetermined intervals in the lamination direction; and
one of the following conditions is satisfied:
$$1 \leq N \leq 12 and 2 \leq M \leq 12 ; and$$
$$2 \leq N \leq 12 and 1 \leq M \leq 12 .$$

17. The multi-unit multilayer ceramic capacitor according to claim 11, wherein a dimension of the multilayer body in the height direction is about 1.00 mm or less.

18. The multi-unit multilayer ceramic capacitor according to claim 11, wherein a dimension of the multilayer body in the length direction is about 0.2 mm or more and about 20.0 mm or less.

19. The multi-unit multilayer ceramic capacitor according to claim 11, wherein a dimension of the multilayer body in the height direction is about 0.2 mm or more and about 1.0 mm or less.

20. The multi-unit multilayer ceramic capacitor according to claim 11, wherein a dimension of the multilayer body in the width direction is about 0.2 mm or more and about 20.0 mm or less.
